(19) United States
(12) Patent Application Publication
(10) Pub. No.: US 2019/0052610 A1
(43) Pub. Date: Feb. 14, 2019

(54) APPARATUS AND METHOD FOR ENCAPSULATION OF PROFILE CERTIFICATE PRIVATE KEYS OR OTHER DATA

(71) Applicant: Honeywell International Inc., Morris Plains, NJ (US)

(72) Inventors: Lukas Pohanka, Prague (CZ); Michal Hojsik, Prague (CZ); Jiri Bazant, Nova Paka (CZ)

(21) Appl. No.: 15/675,656

(22) Filed: Aug. 11, 2017

(51) Int. Cl. H04L 29/06

(52) U.S. Cl. CPC H04L 63/0435; H04L 63/061; H04L 63/102; H04L 63/0853; H04L 63/0869

(57) ABSTRACT

A method includes generating a first encryption key based on a first cryptographic operation performed by cryptographic circuitry and involving a cryptographic key securely stored in a memory of the cryptographic circuitry. The method also includes encrypting data to be protected using the first encryption key and storing the encrypted data on a persistent storage device external to the cryptographic circuitry. The method could also include retrieving the encrypted data from the persistent storage device. The method could further include generating a second encryption key based on a second cryptographic operation performed by the cryptographic circuitry and involving the cryptographic key, where the second encryption key matches the first encryption key. In addition, the method could include decrypting the encrypted data using the second encryption key.

### TECHNICAL FIELD

This disclosure generally relates to computing and networking security. More specifically, this disclosure relates to an apparatus and method for encapsulation of profile certificate private keys or other data.

### BACKGROUND

It is becoming more and more common for computing devices and other devices to communicate with multiple remote services over public or private networks. Examples of this trend can be seen in so-called Internet of Things (“IoT”) devices, which typically refer to physical devices such as appliances, vehicles, building equipment, and other components that are networked for data exchange. Industrial Internet of Things (“IIoT”) devices are IoT devices like sensors, actuators, controllers, and other devices in industrial process control and automation systems, which are used to automate large and complex industrial processes.

IoT or other devices are often required to present security credentials to remote services, such as pre-shared passwords or digital certificates. This is typically done to establish mutually-authenticated connections to the remote services. However, establishing different mutually-authenticated connections to different remote services usually requires the use of unique client configuration services and unique sets of security credentials. As a result, a device typically needs to have access to multiple “profiles” that are used to access different remote services. While these profiles are often highly sensitive, it can be difficult to securely store multiple profiles in a device.

### SUMMARY

This disclosure provides an apparatus and method for encapsulation of profile certificate private keys or other data.

In a first embodiment, an apparatus includes a storage device and cryptographic circuitry having a memory configured to securely store a cryptographic key. The cryptographic circuitry is configured to generate a first encryption key based on a first cryptographic operation performed by the cryptographic circuitry and involving the cryptographic key. The cryptographic circuitry or at least one processor is configured to encrypt data to be protected using the first encryption key and to store the encrypted data on the storage device.

In a second embodiment, a method includes generating a first encryption key based on a first cryptographic operation performed by cryptographic circuitry and involving a cryptographic key securely stored in a memory of the cryptographic circuitry. The method also includes encrypting data to be protected using the first encryption key and storing the encrypted data on a persistent storage device external to the cryptographic circuitry.

In a third embodiment, one or more non-transitory computer readable media contain instructions that when executed cause a device having at least a persistent storage device and cryptographic circuitry to generate a first encryption key based on a first cryptographic operation performed by the cryptographic circuitry and involving a cryptographic key securely stored in a memory of the cryptographic circuitry. The one or more media also contain instructions that when executed cause the device to encrypt data to be protected using the first encryption key and store the encrypted data on the persistent storage device external to the cryptographic circuitry.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system having devices that support encapsulation of profile certificate private keys or other data according to this disclosure;

FIG. 2 illustrates an example device that supports encapsulation of profile certificate private keys or other data according to this disclosure;

FIG. 3 illustrates example operations and contents of a device that supports encapsulation of profile certificate private keys or other data according to this disclosure;

FIGS. 4 and 5 illustrate first example methods for encrypting and decrypting profile certificate private keys or other data according to this disclosure; and

FIGS. 6 and 7 illustrate second example methods for encrypting and decrypting profile certificate private keys or other data according to this disclosure.

### DETAILED DESCRIPTION

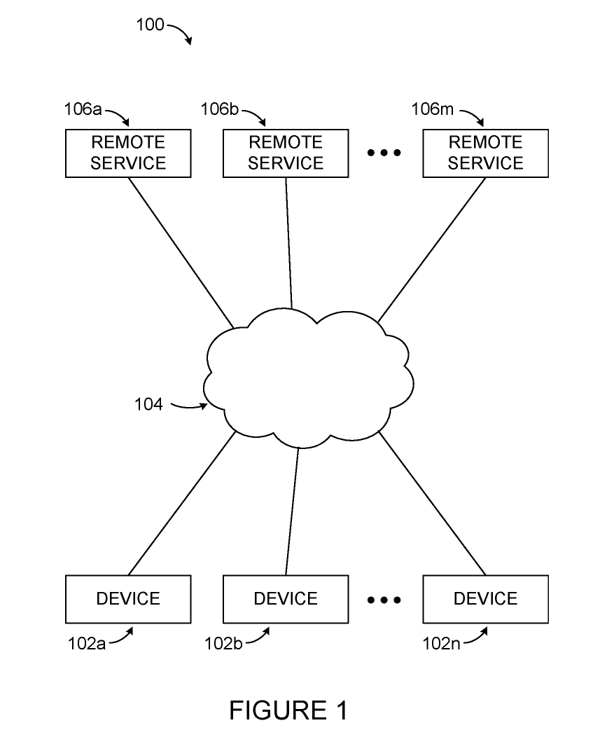

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

As noted above, devices routinely need to store sensitive data, such as profiles that are used by the device to access different remote services, in a secure manner. Some conventional devices have incorporated cryptographic circuitry that can securely store private cryptographic keys or other data. However, it is common for cryptographic chips to include a very limited amount of internal memory for storing data. This restricts the numbers or types of cryptographic keys that can be stored in the cryptographic chips. This can become problematic in a number of situations, such as when a device needs to store an increasing number of profiles in order to communicate with an increasing number of remote services.

This disclosure provides various techniques for encapsulating private cryptographic keys for profile certificates or other data. These techniques could be used in a number of applications to secure sensitive or other data. Note that the description below tends to focus on remote services that require a device to present (i) a valid digital certificate and (ii) proof that the device possesses the certificate's corresponding private cryptographic key. While the sensitive data in this example is the private key for each remote service profile, the techniques described in this document could be used to protect any other information. Also note that, in the following description, these techniques may be described as involving specific types of cryptographic keys (such as elliptic curve or “EC” private keys) and specific types of cryptographic operations (such as elliptic curve Diffie-Hellman or “ECDH” computations). However, these details are for illustration and explanation only. The techniques described in this document could involve the use of any suitable cryptographic keys and any suitable cryptographic operations (now known or later developed), such as classical Diffie-Hellman (“DH”) private keys.

FIG. 1 illustrates an example system 100 having devices that support encapsulation of profile certificate private keys or other data according to this disclosure. As shown in FIG. 1, the system 100 includes a number of devices 102a-102n, which can communicate over at least one network 104 with various remote services 106a-106m. Each of the devices 102a-102n denotes any suitable device or system configured to communicate over at least one network and to encapsulate profile certificate private keys or other data as described below. As particular examples, each of the devices 102a-102n could denote a desktop computer, laptop computer, tablet computer, mobile smartphone, or other computing device. As other particular examples, each of the devices 102a-102n could denote an Internet of Things (“IoT”) device, such as an appliance, vehicle, building equipment, or other component that is networked for data exchange. As yet other particular examples, each of the devices 102a-102n could denote an Industrial Internet of Things (“IIoT”) device, such as a sensor, actuator, controller, or other device in an industrial process control and automation system (which can be used to automate one or more industrial processes).

The network 104 facilitates communications between various components in the system 100. For example, the network 104 may communicate Internet Protocol (“IP”) packets or other information between network addresses. The network 104 could support communications over any suitable physical or wireless connections. The network 104 may include one or more local area networks (“LANs”), metropolitan area networks (“MANs”), wide area networks (“WANs”), all or a portion of a global network such as the Internet, or any other communication system or systems at one or more locations.

Each of the remote services 106a-106m denotes any suitable device or system configured to provide one or more services to one or more of the devices 102a-102n. The functions performed by the remote services 106a-106m can vary widely depending on a number of factors, such as the type(s) of device(s) 102a-102n being provided the service(s). For example, devices 102a-102n that represent home or business computing devices could receive cyber-security, data backup, file or hardware management, or other services from various remote sites. Devices 102a-102n that represent IoT devices could receive cyber-security, device monitoring, or other services from various remote sites. Devices 102a-102n that represent IIoT devices could receive cyber-security, device monitoring/configuration/diagnosis, process historian, or other services from various remote sites. Each of the remote services 106a-106m could be implemented in any suitable manner, such as by using one or more servers, computing clouds, or other components.

One or more of the devices 102a-102n may need to store sensitive data, such as one or more profiles that are used by the devices 102a-102n to access one or more of the remote services 106a-106m. As described in more detail below, at least one of the devices 102a-102n could include cryptographic circuitry and a persistent storage device or other data storage device. The cryptographic circuitry can be used to store at least one master private or secret cryptographic key and perform various cryptographic operations. The device 102a-102n can use the cryptographic circuitry to encrypt various data, such as one or more private keys that are associated with one or more digital certificates used by the device 102a-102n to access one or more of the remote services 106a-106m. The encrypted data can then be stored on the persistent storage device or other data storage device.

Although FIG. 1 illustrates one example of a system 100 having devices that support encapsulation of profile certificate private keys or other data, various changes may be made to FIG. 1. For example, the system 100 could include any number of devices, networks, remote services, and other components in any suitable configuration. Moreover, numerous systems could contain devices that need to protect information. The system 100 shown in FIG. 1 is meant to illustrate one example operational environment in which encapsulation of profile certificate private keys or other data may be needed or desired. However, FIG. 1 does not limit this disclosure to any particular configuration or operational environment. In general, the techniques described in this patent document can be used in any suitable system.

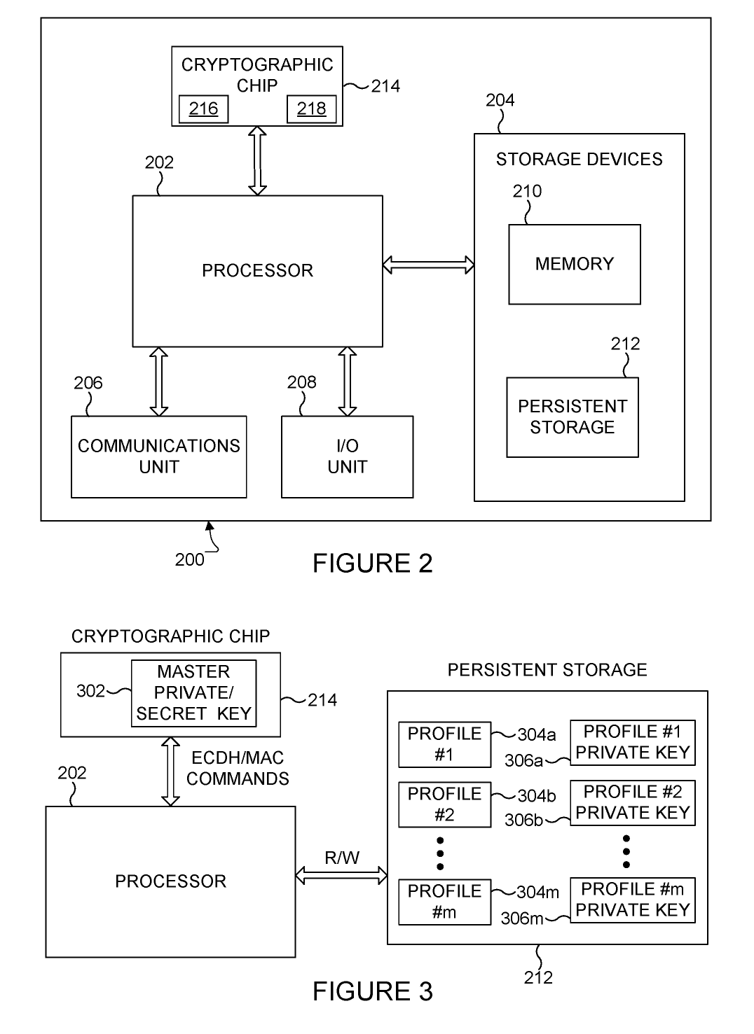

FIG. 2 illustrates an example device 200 that supports encapsulation of profile certificate private keys or other data according to this disclosure. The device 200 could, for example, represent any of the devices 102a-102n shown in FIG. 1 and described above. However, the device 200 could represent any other suitable system where encapsulation of profile certificate private keys or other data may be needed or desired.

As shown in FIG. 2, the device 200 includes at least one processor 202, at least one storage device 204, at least one communications unit 206, and at least one input/output (“I/O”) unit 208. Each processor 202 can execute instructions, such as those that may be loaded into a memory 210. For example, the instructions can implement various functions described below for encapsulating profile certificate private keys or other data. Each processor 202 denotes any suitable processing device, such as one or more microprocessors, microcontrollers, digital signal processors, application specific integrated circuits (“ASICs”), field programmable gate arrays (“FPGAs”), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc. At least one of the storage devices 204 represents a device to which the processor 202 has both read access and write access.

The communications unit 206 supports communications with other systems or devices. For example, the communications unit 206 could include at least one network interface card or wireless transceiver facilitating communications over at least one wired or wireless network, such as the network 104. The communications unit 206 may support communications through any suitable physical or wireless communication link(s). Note, however, that some embodiments of the device 200 could omit a communications unit 206, such as when the device 200 is used to store sensitive data without sending data over a network.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that some embodiments of the device 200 could omit an I/O unit 208, such as when the device 200 is accessed via the network 104 and does not include a local I/O interface.

In addition, the device 200 includes cryptographic circuitry in the form of a cryptographic chip 214, which contains processing circuitry 216 and at least one internal memory 218. The processing circuitry 216 of the cryptographic chip 214 is configured to perform various cryptographic operations, such as ECDH or Message Authentication Code (“MAC”) computations. At least some of the computations involve one or more private or secret keys stored in the internal memory 218, such as one or more EC or DH private keys, symmetric secret keys, or other cryptographic keys. As a particular example, the internal memory 218 could store one or more U.S. National Institute of Standards and Technology (“NIST”) P-256 private keys. The cryptographic chip 214 can also be tamper-resistant or tamper-proof to limit or prevent illicit access to the data stored in the internal memory 218. The cryptographic chip 214 includes any suitable integrated circuitry for performing cryptographic operations, including cryptographic operations that involve data securely stored on the integrated circuitry.

As described in more detail below, the processor 202 can interact with the cryptographic chip 214 to allow for storage of data in a persistent storage 212 or other storage device 204 in a secure manner. For example, the processor 202 can request that the cryptographic chip 214 perform various cryptographic operations with at least one private or secret key stored in the internal memory 218 of the cryptographic chip 214. As particular examples, the processor 202 can instruct the cryptographic chip 214 to perform ECDH computations using at least one private key securely stored in the internal memory 218, or the processor 202 can instruct the cryptographic chip 214 to perform MAC computations using at least one secret key securely stored in the internal memory 218.

Using these cryptographic operations, the device 200 can securely store various data outside of the cryptographic chip 214, such as in the persistent storage 212 or other storage device 204. The device 200 is not limited to storing data securely within the internal memory 218 of the cryptographic chip 214. This can be beneficial in various circumstances. For example, devices routinely have much larger persistent storage or other data storage devices (in terms of storage capacity) compared to the internal storage of the cryptographic chip 214. As another example, the device 200 could be used in situations where the cryptographic chip 214 can store and use certain types of cryptographic keys (such as EC keys), while profiles are required to contain other types of cryptographic keys (such as RSA keys). This approach helps to ensure that sensitive key information or other data cannot be read by unauthorized third parties. This approach also helps to reduce the amount of data stored in the internal memory 218 of the cryptographic chip 214 and to control the types of data stored in the internal memory 218 of the cryptographic chip 214.

Note that the use of both a processor 202 and a cryptographic chip 214 is not required. One, some, or all of the operations described as being performed by the processor 202 could alternatively be performed by the cryptographic chip 214. This could be accomplished in various ways. For example, the processing circuitry 216 of the cryptographic chip 214 could be designed to perform various operations described as being performed by the processor 202. As another example, the cryptographic chip 214 could be embedded within the processor 202.

Although FIG. 2 illustrates one example of a device 200 that supports encapsulation of profile certificate private keys or other data, various changes may be made to FIG. 2. For example, components could be added, omitted, combined, further subdivided, or placed in any other suitable configuration according to particular needs. As a particular example, while the cryptographic chip 214 is shown here as being externally connected to the processor 202, the cryptographic chip 214 could be embedded within the processor 202 itself as noted above. Also, computing devices can come in a wide variety of configurations, and FIG. 2 does not limit this disclosure to any particular configuration of computing device. As noted above, various other types of devices can be used here, such as IoT or IIoT devices, which can contain a wide variety of other or additional components.

FIG. 3 illustrates example operations and contents of a device that supports encapsulation of profile certificate private keys or other data according to this disclosure. For ease of explanation, the operations and contents shown in FIG. 3 are described with respect to the device 200 of FIG. 2. However, the same or similar operations and contents could be used with any other suitable device, such as IoT or IIoT devices.

As shown in FIG. 3, the cryptographic chip 214 includes at least one private or secret cryptographic key 302. The cryptographic key 302 could denote an asymmetric cryptographic key, such as when the cryptographic key 302 denotes a private key (used by the device 200) that is associated with a public key (used by other devices to communicate with the device 200) in a key pair. The cryptographic key 302 could also denote a symmetric cryptographic key, such as when the cryptographic key 302 denotes a secret key that is used by the device 200 for MAC computations and by other devices to communicate with the device 200.

The processor 202 can issue various commands to the cryptographic chip 214. Examples of these commands can include commands that invoke ECDH or MAC computations by the cryptographic chip 214. These commands can include various other data used in the ECDH or MAC computations, such as initialization vectors, unpredictable values, or public keys. The computations can also involve data stored by the cryptographic chip 214, such as the cryptographic key 302. In addition, the processor 202 or the cryptographic chip 214 has read/write (“R/W”) access to the persistent storage 212 or other storage device 204. This allows the processor 202 or cryptographic chip 214 to read data from and write data to the persistent storage 212 or other storage device 204.

The device 200 in this example also includes various profiles 304a-304m, which are associated with different remote services 106a-106m. Prior to an enrollment process, a profile 304a-304m is unenrolled, meaning there is no digital certificate issued for that profile 304a-304m. The profile 304a-304m at that point could include information that will be encoded into a certificate request to be sent to a remote service 106a-106m, as well as information about a corresponding private key 306a-306m that could be generated before the enrollment request occurs. There are various mechanisms known in the art for generating profiles and enrolling profiles with remote services.

Once the device 200 has gone through an appropriate certificate enrollment process with a remote service 106a-106m, a profile 304a-304m corresponding to the remote service 106a-106m then includes a digital certificate issued for that specific remote service 106a-106m. The digital certificate is also associated with a corresponding private key 306a-306m. At that point, the profile 304a-304m can be used to establish a mutually-authenticated connection between the device 200 and the remote service 106a-106m. For instance, the remote service 106a-106m can determine that the device 200 has a valid digital certificate and that the device 200 possesses the certificate's corresponding private key 306a-306m.

After a profile's private key 306a-306m is generated, a potential security issue could arise if the private key 306a-306m is stored on a storage device 204 in an unencrypted manner. For example, an attacker who gains access to the persistent storage 212 (either locally or remotely) could read out the profile private keys 306a-306m. The various encapsulation schemes described below could be used to securely store the private keys 306a-306m in the persistent storage 212 or other storage device 204, which provides improved security against attackers who gain access to the storage device 204. These schemes make use of the capabilities of the cryptographic chip 214, which can securely store one or more private or secret cryptographic keys. The private or secret cryptographic key(s) can be used to encapsulate an arbitrary number of profile private keys 306a-306m of any type before the profile private keys 306a-306m are stored to the persistent storage 212 or other storage device 204. Note that the encapsulation of the private keys 306a-306m represents one example use of the encapsulation schemes in this document and that other data could also be secured in the same or similar manner.

The techniques described below rely on the fact that an attacker cannot perform operations using the cryptographic chip 214. For example, an attacker cannot perform ECDH computations using the private key stored on the cryptographic chip 214 or MAC computations using the secret key stored on the cryptographic chip 214. These techniques therefore provide security against attackers who gain read/write access to a profile private key storage (the persistent storage 212 or other storage device 204) but do not have access to the cryptographic chip 214. For instance, the techniques described below can store the profile private keys 306a-306m or other data in an already-encrypted form to the persistent storage 212 or other storage device 204. This allows secure storage of the profile private keys 306a-306m or other data and helps to ensure the integrity of the stored profile private keys 306a-306m or other data.

Although FIG. 3 illustrates examples of operations and contents of a device 200 that supports encapsulation of profile certificate private keys or other data, various changes may be made to FIG. 3. For example, the device 200 could support any suitable number of profiles and profile keys. Also, as noted above, various other types of devices can be used here, such as IoT or IIoT devices, which can contain a wide variety of other or additional components.

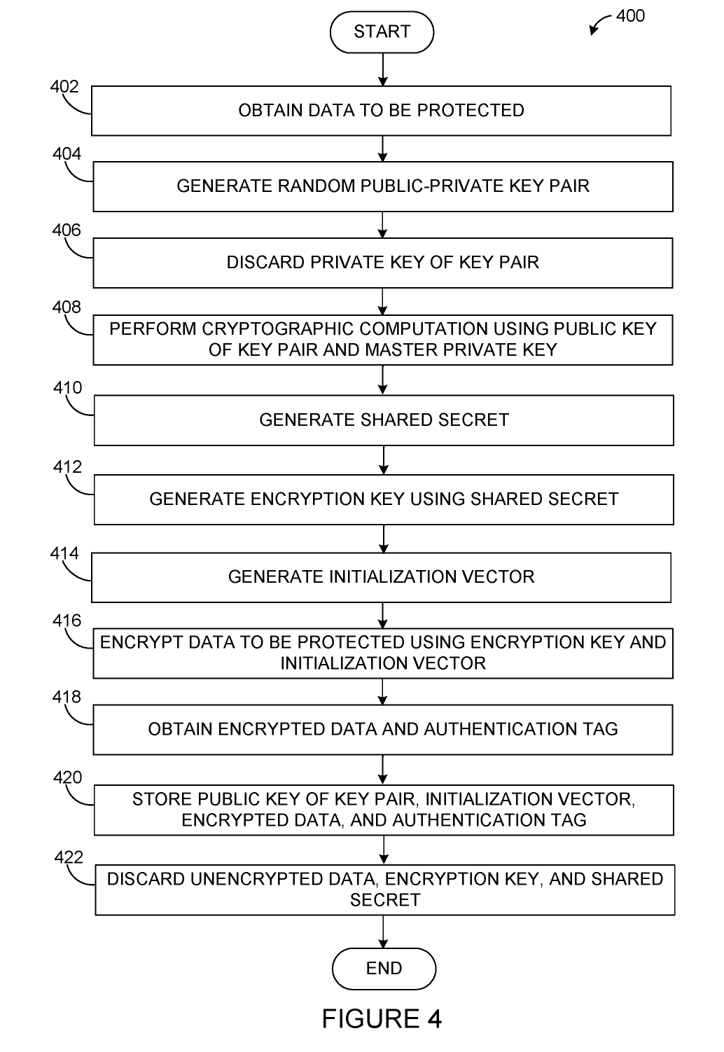

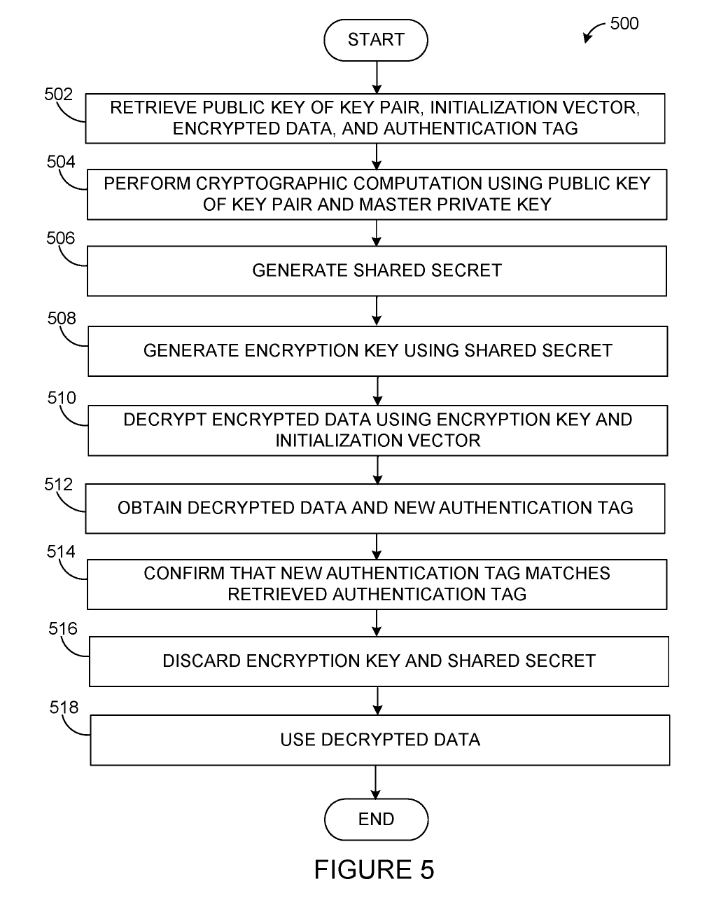

FIGS. 4 and 5 illustrate first example methods for encrypting and decrypting profile certificate private keys or other data according to this disclosure. In particular, FIGS. 4 and 5 illustrate example methods 400 and 500 for encrypting and decrypting profile certificate private keys or other data based on an asymmetric private cryptographic key. For ease of explanation, the methods 400 and 500 shown in FIGS. 4 and 5 are described with respect to the device 200 of FIG. 2 operating in the system 100 of FIG. 1. However, the methods 400 and 500 could be performed using any suitable device(s) in any suitable system(s).

FIG. 4 illustrates an example method 400 for encrypting profile certificate private keys or other data based on an asymmetric private cryptographic key. As shown in FIG. 4, data to be protected is obtained at step 402. This could include, for example, the processor 202 or the cryptographic chip 214 of the device 200 obtaining a private cryptographic key 306a-306m associated with a profile 304a-304m. The profile 304a-304m could be used by the device 200 to interact with a remote service 106a-106m. The private cryptographic key 306a-306m could be obtained in any suitable manner, such as by generating the private cryptographic key 306a-306m using any suitable technique (now known or later developed). Note, however, that the data to be protected could also be generated by other components of the device 200 or even outside the device 200 and provided to the processor 202 or the cryptographic chip 214 of the device 200. Of course, any other suitable data to be protected could also be obtained.

A random public-private key pair (often called an “ephemeral” key pair) is generated at step 404. This could include, for example, the processor 202 or the cryptographic chip 214 of the device 200 generating a random private-public elliptic curve key pair or other asymmetric key pair using any suitable technique (now known or later developed). The private key of the key pair is discarded at step 406. This could include, for example, the processor 202 or the cryptographic chip 214 of the device 200 securely erasing the private key of the key pair from an associated memory.

At least one cryptographic computation is performed using the public key of the key pair and a master private key at step 408, which allows a shared secret to be generated at step 410. This could include, for example, the processor 202 of the device 200 requesting that the cryptographic chip 214 of the device 200 perform one or more ECDH computations or other cryptographic computations using the public key of the key pair and at least one private cryptographic key 302 stored in the cryptographic chip 214. This could also include the processor 202 of the device 200 receiving the result of the cryptographic computation(s), which denotes the shared secret. The cryptographic chip 214 could also perform these operations without interaction with a processor 202. Any suitable computations could occur here, as long as the result is unique based on the public key of the key pair and the at least one private cryptographic key 302.

An encryption key is generated using the shared secret at step 412. This could include, for example, the processor 202 or the cryptographic chip 214 of the device 200 applying a key derivation function (KDF) or other function to the shared secret to obtain an encryption key for the data to be protected. An initialization vector is generated at step 414. This could include, for example, the processor 202 or the cryptographic chip 214 of the device 200 generating a 16-byte or other unique value using any suitable technique (now known or later developed). In some embodiments, the unique value can denote an unpredictable value that cannot be easily determined by an attacker and may or may not represent a cryptographically random value. Such an unpredictable as well as unique value may be needed with some encryption schemes. Note, however, that there are also encryption schemes that do not require the use of an initialization vector at all, such as the AES-ECB scheme. In such cases, the generation and use of an initialization vector can be omitted.

The data to be protected is encrypted using the encryption key and the initialization vector at step 416, which allows encrypted data and an authentication tag to be obtained at step 418. This could include, for example, the processor 202 or the cryptographic chip 214 of the device 200 using a suitable encryption scheme, such as an Authenticated Encryption Additional Data (AEAD) encryption scheme like the AES128-GCM encryption scheme, to encrypt the data to be protected and generate the encrypted data and the authentication tag.

The public key of the key pair, the initialization vector, the encrypted data, and the authentication tag are stored at step 420. This could include, for example, the processor 202 or the cryptographic chip 214 of the device 200 storing this data in a persistent storage 212 or other storage device 204. As a particular example, this could include the processor 202 or the cryptographic chip 214 of the device 200 storing this data as part of a profile 304a-304m in the persistent storage 212 or other storage device 204. The unencrypted data, encryption key, and shared secret are discarded at step 422. This could include, for example, the processor 202 or the cryptographic chip 214 of the device 200 securely erasing the unencrypted data, encryption key, and shared secret from an associated memory or memories.

FIG. 5 illustrates an example method 500 for decrypting profile certificate private keys or other data based on an asymmetric private cryptographic key. As shown in FIG. 5, a public key of a public-private key pair, an initialization vector, encrypted data, and an authentication tag are retrieved at step 502. This could include, for example, the processor 202 or the cryptographic chip 214 of the device 200 retrieving this data from a persistent storage 212 or other storage device 204. As a particular example, this could include the processor 202 or the cryptographic chip 214 of the device 200 retrieving this data from a profile 304a-304m in the persistent storage 212 or other storage device 204.

At least one cryptographic computation is performed using the public key of the key pair and a master private key at step 504, which allows a shared secret to be generated at step 506. This could include, for example, the processor 202 of the device 200 requesting that the cryptographic chip 214 of the device 200 perform one or more ECDH computations or other cryptographic computations using the public key of the key pair and at least one private cryptographic key 302 stored in the cryptographic chip 214. This could also include the processor 202 of the device 200 receiving the result of the cryptographic computation(s), which denotes the shared secret. The cryptographic chip 214 could also perform these operations without interaction with a processor 202. Any suitable computations could occur here, as long as the result is unique based on the public key of the key pair and the at least one private cryptographic key 302. An encryption key is generated using the shared secret at step 508. This could include, for example, the processor 202 or the cryptographic chip 214 of the device 200 applying a key derivation function or other function to the shared secret to obtain an encryption key. The shared secret and the encryption key generated here are the same shared secret and encryption key generated at steps 410-412 during the encryption process.

The encrypted data is decrypted using the encryption key and the initialization vector at step 510, which allows decrypted data and a new authentication tag to be obtained at step 512. This could include, for example, the processor 202 or the cryptographic chip 214 of the device 200 using a suitable decryption scheme, such as the AES128-GCM decryption scheme, to decrypt the data and generate the decrypted data and the new authentication tag.

A confirmation is obtained that the new authentication tag matches the retrieved authentication tag at step 514. This could include, for example, the processor 202 or the cryptographic chip 214 of the device 200 comparing the new authentication tag generated for the decrypted data with the authentication tag retrieved from the persistent storage 212 or other storage device 204. Matching authentication tags indicate that the decryption was successful and the decrypted data is valid. If such a confirmation cannot be made, the decrypted data is invalid, and the decrypted data could be discarded or ignored. Note that while the decryption and confirmation operations are shown as separate steps here, the decryption itself could include a check that the authentication tags match.

The encryption key and the shared secret are discarded at step 516. This could include, for example, the processor 202 or the cryptographic chip 214 of the device 200 securely erasing the encryption key and the shared secret from an associated memory or memories. Assuming the authentication tags match, the decrypted data can be used in any suitable manner at step 518. This could include, for example, the processor 202 or the cryptographic chip 214 of the device 200 using decrypted data representing a profile private key to interact with a remote service 106a-106m. As a particular example, the device 200 could provide a digital certificate to the remote service 106a-106m. The device 200 could also perform one or more cryptographic operations using the profile private key associated with the digital certificate to confirm to the remote service 106a-106m that the device 200 possesses the digital certificate's corresponding private cryptographic key. Of course, any other suitable actions could occur involving the decrypted data.

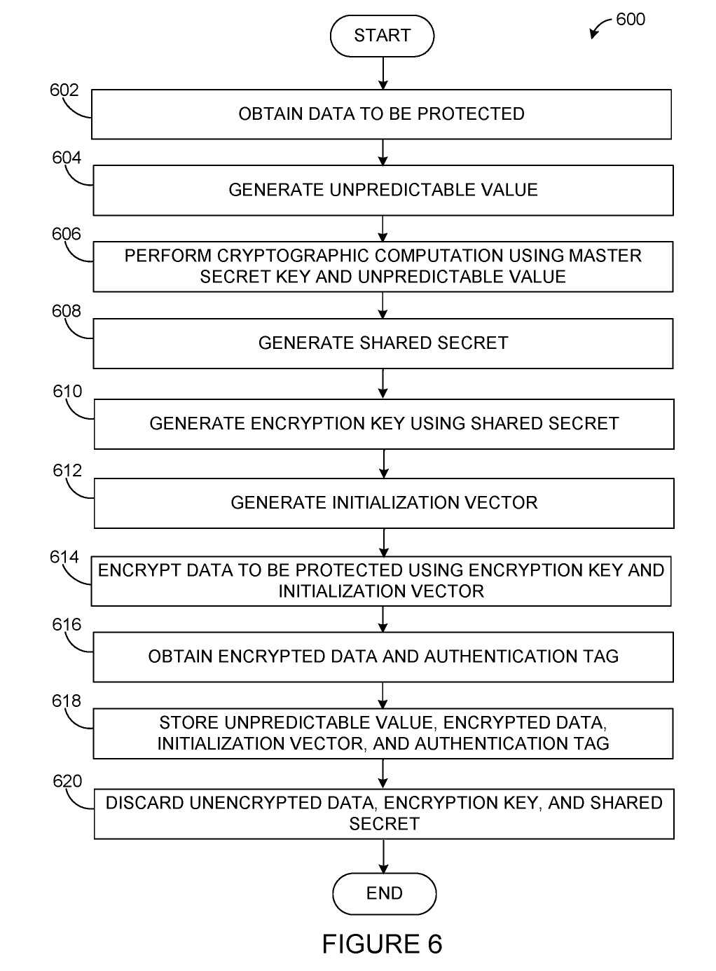

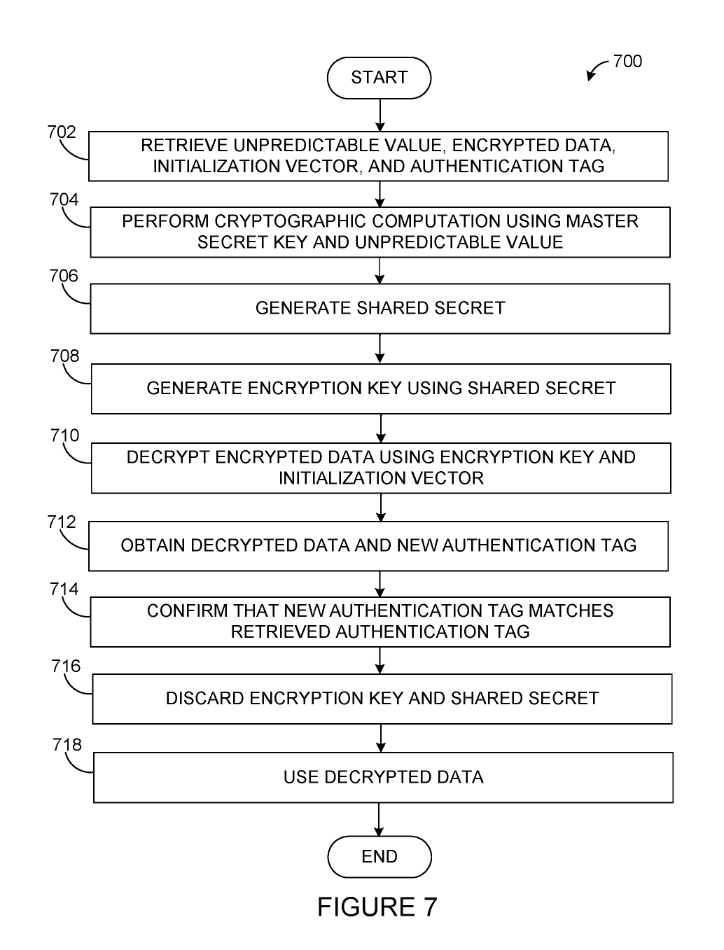

FIGS. 6 and 7 illustrate second example methods for encrypting and decrypting profile certificate private keys or other data according to this disclosure. In particular, FIGS. 6 and 7 illustrate example methods 600 and 700 for encrypting and decrypting profile certificate private keys or other data based on a symmetric secret cryptographic key. For ease of explanation, the methods 600 and 700 shown in FIGS. 6 and 7 are described with respect to the device 200 of FIG. 2 operating in the system 100 of FIG. 1. However, the methods 600 and 700 could be performed using any suitable device(s) in any suitable system(s).

FIG. 6 illustrates an example method 600 for encrypting profile certificate private keys or other data based on a symmetric secret cryptographic key. As shown in FIG. 6, data to be protected is obtained at step 602. This could include, for example, the processor 202 or the cryptographic chip 214 of the device 200 obtaining a private cryptographic key 306a-306m associated with a profile 304a-304m. As noted above, the profile 304a-304m could be used by the device 200 to interact with a remote service 106a-106m. The private cryptographic key 306a-306m could be obtained in any suitable manner, such as by generating the private cryptographic key 306a-306m using any suitable technique (now known or later developed). Note, however, that the data to be protected could also be generated by other components of the device 200 or even outside the device 200 and provided to the processor 202 or the cryptographic chip 214 of the device 200. Of course, any other suitable data to be protected could also be obtained.

An unpredictable value is generated at step 604. This could include, for example, the processor 202 or the cryptographic chip 214 of the device 200 generating a random or other unpredictable and unique value that is 128 bits long (or any other suitable length) using any suitable technique (now known or later developed). At least one cryptographic computation is performed using the unpredictable value and a master secret key at step 606, which allows a shared secret to be generated at step 608. This could include, for example, the processor 202 of the device 200 requesting that the cryptographic chip 214 of the device 200 perform one or more MAC computations or other cryptographic computations using the unpredictable value and at least one secret cryptographic key 302 stored in the cryptographic chip 214. This could also include the processor 202 of the device 200 providing the unpredictable value to the cryptographic chip 214 if the processor 202 generated the unpredictable value. This could further include the processor 202 of the device 200 receiving the result of the cryptographic computation(s), which denotes the shared secret. The cryptographic chip 214 could also perform these operations without interaction with a processor 202. Any suitable computations could occur here, as long as the result is unique based on the unpredictable value and the at least one secret cryptographic key 302.

An encryption key is generated using the shared secret at step 610. This could include, for example, the processor 202 or the cryptographic chip 214 of the device 200 applying a key derivation function or other function to the shared secret to obtain an encryption key for the data to be protected. An initialization vector is generated at step 612. This could include, for example, the processor 202 or the cryptographic chip 214 of the device 200 generating a 16-byte or other unique value using any suitable technique (now known or later developed). Again, however, if the encryption scheme does not require an initialization vector, this step can be omitted.

The data to be protected is encrypted using the encryption key and the initialization vector at step 614, which allows encrypted data and an authentication tag to be obtained at step 616. This could include, for example, the processor 202 or the cryptographic chip 214 of the device 200 using a suitable encryption scheme, such as the AES128-GCM encryption scheme, to encrypt the data to be protected and generate the encrypted data and the authentication tag.

The unpredictable value, the encrypted data, the initialization vector, and the authentication tag are stored at step 618. This could include, for example, the processor 202 or the cryptographic chip 214 of the device 200 storing this data in a persistent storage 212 or other storage device 204. As a particular example, this could include the processor 202 or the cryptographic chip 214 of the device 200 storing this data as part of a profile 304a-304m in the persistent storage 212 or other storage device 204. The unencrypted data, encryption key, and shared secret are discarded at step 620. This could include, for example, the processor 202 or the cryptographic chip 214 of the device 200 securely erasing the unencrypted data, encryption key, and shared secret from an associated memory or memories.

FIG. 7 illustrates an example method 700 for decrypting profile certificate private keys or other data based on a symmetric secret cryptographic key. As shown in FIG. 7, an unpredictable value, encrypted data, an initialization vector, and an authentication tag are retrieved at step 702. This could include, for example, the processor 202 or the cryptographic chip 214 of the device 200 retrieving this data from a persistent storage 212 or other storage device 204. As a particular example, this could include the processor 202 or the cryptographic chip 214 of the device 200 retrieving this data from a profile 304a-304m in the persistent storage 212 or other storage device 204.

At least one cryptographic computation is performed using the unpredictable value and a master secret key at step 704, which allows a shared secret to be generated at step 706. This could include, for example, the processor 202 of the device 200 requesting that the cryptographic chip 214 of the device 200 perform one or more MAC computations or other cryptographic computations using the unpredictable value and at least one secret cryptographic key 302 stored in the cryptographic chip 214. This could also include the processor 202 of the device 200 receiving the result of the cryptographic computation(s), which denotes the shared secret. The cryptographic chip 214 could also perform these operations without interaction with a processor 202. Any suitable computations could occur here, as long as the result is unique based on the unpredictable value and the at least one secret cryptographic key 302. An encryption key is generated using the shared secret at step 708. This could include, for example, the processor 202 or the cryptographic chip 214 of the device 200 applying a key derivation function or other function to the shared secret to obtain an encryption key. The shared secret and the encryption key generated here are the same shared secret and encryption key generated at steps 608-610 during the encryption process.

The encrypted data is decrypted using the encryption key and the initialization vector at step 710, which allows decrypted data and a new authentication tag to be obtained at step 712. This could include, for example, the processor 202 or the cryptographic chip 214 of the device 200 using a suitable decryption scheme, such as the AES128-GCM decryption scheme, to decrypt the data and generate the decrypted data and the new authentication tag.

A confirmation is obtained that the new authentication tag matches the retrieved authentication tag at step 714. This could include, for example, the processor 202 or the cryptographic chip 214 of the device 200 comparing the new authentication tag generated for the decrypted data with the authentication tag retrieved from the persistent storage 212 or other storage device 204. Matching authentication tags indicate that the decryption was successful and the decrypted data is valid. If such a confirmation cannot be made, the decrypted data is invalid, and the decrypted data could be discarded or ignored. Note that while the decryption and confirmation operations are shown as separate steps here, the decryption itself could include a check that the authentication tags match.

The encryption key and the shared secret are discarded at step 716. This could include, for example, the processor 202 or the cryptographic chip 214 of the device 200 securely erasing the encryption key and the shared secret from an associated memory or memories. Assuming the authentication tags match, the decrypted data can be used in any suitable manner at step 718. This could include, for example, the processor 202 or the cryptographic chip 214 of the device 200 using decrypted data representing a profile private key to interact with a remote service 106a-106m. As a particular example, the device 200 could provide a digital certificate to the remote service 106a-106m. The device 200 could also perform one or more cryptographic operations using the profile private key associated with the digital certificate to confirm to the remote service 106a-106m that the device 200 possesses the digital certificate's corresponding private cryptographic key. Of course, any other suitable actions could occur involving the decrypted data.

In these ways, data to be protected can be encrypted using a private or secret cryptographic key 302 and then stored in a persistent storage 212 or other storage device 204. The data can also be retrieved from the persistent storage 212 or other storage device 204 and decrypted using the private or secret cryptographic key 302. The encrypted data may be accessible if an attacker gains access to the persistent storage 212 or other storage device 204 (either locally or remotely). However, since the attacker cannot perform operations using the cryptographic chip 214, the attacker cannot decrypt the data on the persistent storage 212 or other storage device 204 that is encrypted using the cryptographic chip 214.

An example use of this functionality involves encrypting private keys 306a-306m associated with profiles 304a-304m used by the device 200 to interact with remote services 106a-106m. The private keys 306a-306m can be stored long-term in the persistent storage 212 or other storage device 204, rather than in the internal memory 218 of the cryptographic chip 214. This enables the device 200 to interact with an increasing number of remote services 106a-106m without having the store the private keys 306a-306m associated with those remote services 106a-106m in the (typically smaller) internal memory 218 of the cryptographic chip 214. Moreover, this can be accomplished while protecting the profile private keys 306a-306m from attackers.

Although FIGS. 4 through 7 illustrate examples of methods for encrypting and decrypting profile certificate private keys or other data, various changes may be made to FIGS. 4 through 7. For example, while each figure is shown as a series of steps, various steps in each figure could overlap, occur in parallel, occur in a different order, or occur any number of times. As a particular example, it is possible to combine steps 412-414 in FIG. 4 or steps 610-612 in FIG. 6 by generating an encryption key and an initialization vector using the same shared secret. For instance, the key derivation function or other function applied to the shared secret could generate an additional 16 bytes (or other amount) of data in addition to the encryption key, and the additional data could be used as the initialization vector in FIG. 4 or FIG. 6. If this approach is used, the same process could be used in step 508 of FIG. 5 or step 708 of FIG. 7 to obtain both the encryption key and the initialization vector. Also, if this approach is used, the initialization vector need not be stored at step 420 or 618 and need not be retrieved at step 502 or 702. In some cases, the scheme does not require an initialization vector at all (such as with AES-ECB), and its generation and use can be omitted entirely.

Moreover, various steps shown in FIGS. 4 through 7 could be omitted if needed or desired. For example, discarding operations could be skipped if data is stored in the internal memory 218 of a tamper-proof cryptographic chip 214 such that the data could not be obtained by an attacker. Discarding operations could also be skipped if data is overwritten quickly or is otherwise difficult to obtain.

In addition, note that while shown as involving the generation and use of authentication tags, the generation and use of authentication tags may not occur or may not be needed in other embodiments of the methods 400-700. For example, non-AEAD encryption schemes (such as AES-CBC or AES-CTR) could be used here, and these encryption schemes do not generate an authentication tag during encryption or decryption and do not compare authentication tags during decryption.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a storage device; and
cryptographic circuitry comprising a memory configured to securely store a cryptographic key;
wherein the cryptographic circuitry is configured to generate a first encryption key based on a first cryptographic operation performed by the cryptographic circuitry and involving the cryptographic key; and
wherein the cryptographic circuitry or at least one processor is configured to encrypt data to be protected using the first encryption key and to store the encrypted data on the storage device.

2. The apparatus of claim 1, wherein:
the cryptographic circuitry is further configured to generate a second encryption key based on a second cryptographic operation performed by the cryptographic circuitry and involving the cryptographic key, the second encryption key matching the first encryption key; and
the cryptographic circuitry or the at least one processor is further configured to retrieve the encrypted data from the storage device and decrypt the encrypted data using the second encryption key.

3. The apparatus of claim 2, wherein:
the data to be protected comprises one or more private cryptographic keys associated with one or more profiles;
the cryptographic circuitry or the at least one processor is configured to decrypt the one or more private cryptographic keys; and
the at least one processor is configured to use the one or more decrypted private cryptographic keys to establish at least one mutually-authenticated connection with at least one remote service.

4. The apparatus of claim 1, wherein the storage device comprises a persistent storage device having a larger storage capacity than the memory of the cryptographic circuitry.

5. The apparatus of claim 1, wherein:
the cryptographic key comprises an asymmetric private cryptographic key;
the cryptographic circuitry or the at least one processor is configured to generate a public-private key pair;
the cryptographic circuitry is configured to perform the first cryptographic operation using a public key of the public-private key pair and the private cryptographic key to generate a shared secret;
the cryptographic circuitry or the at least one processor is configured to generate the first encryption key using the shared secret; and
the cryptographic circuitry or the at least one processor is configured to encrypt the data to be protected using the first encryption key and an initialization vector.

6. The apparatus of claim 1, wherein:
the cryptographic key comprises a symmetric secret cryptographic key;
the cryptographic circuitry or the at least one processor is configured to generate an unpredictable value;
the cryptographic circuitry is configured to perform the first cryptographic operation using the unpredictable value and the symmetric secret cryptographic key to generate a shared secret;
the cryptographic circuitry or the at least one processor is configured to generate the first encryption key using the shared secret; and
the cryptographic circuitry or the at least one processor is configured to encrypt the data to be protected using the first encryption key and an initialization vector.

7. The apparatus of claim 2, wherein the cryptographic circuitry or the at least one processor is further configured to:
generate a first authentication tag during encryption of the data to be protected;
generate a second authentication tag during decryption of the encrypted data; and
use the decrypted data after confirming that the first and second authentication tags match.

8. The apparatus of claim 1, wherein the cryptographic circuitry is embedded within the at least one processor.

9. A method comprising:
generating a first encryption key based on a first cryptographic operation performed by cryptographic circuitry and involving a cryptographic key securely stored in a memory of the cryptographic circuitry;
encrypting data to be protected using the first encryption key; and
storing the encrypted data on a persistent storage device external to the cryptographic circuitry.

10. The method of claim 9, further comprising:
retrieving the encrypted data from the persistent storage device;
generating a second encryption key based on a second cryptographic operation performed by the cryptographic circuitry and involving the cryptographic key, the second encryption key matching the first encryption key; and
decrypting the encrypted data using the second encryption key.

11. The method of claim 10, wherein:
the data to be protected comprises one or more private cryptographic keys associated with one or more profiles;
decrypting the encrypted data comprises decrypting the one or more private cryptographic keys; and
the method further comprises using the one or more decrypted private cryptographic keys to establish at least one mutually-authenticated connection with at least one remote service.

12. The method of claim 9, wherein the persistent storage device has a larger storage capacity than the memory of the cryptographic circuitry.

13. The method of claim 9, wherein:
the cryptographic key comprises an asymmetric private cryptographic key;
the method further comprises generating a public-private key pair;
the first cryptographic operation is performed using a public key of the public-private key pair and the private cryptographic key to generate a shared secret; and
the first encryption key is generated using the shared secret; and
the data to be protected is encrypted using the first encryption key and an initialization vector.

14. The method of claim 9, wherein:
the cryptographic key comprises a symmetric secret cryptographic key;
the method further comprises generating an unpredictable value;
the first cryptographic operation is performed using the unpredictable value and the symmetric secret cryptographic key to generate a shared secret;
the first encryption key is generated using the shared secret; and
the data to be protected is encrypted using the first encryption key and an initialization vector.

15. The method of claim 10, further comprising:
generating a first authentication tag during encryption of the data to be protected;
generating a second authentication tag during decryption of the encrypted data; and
using the decrypted data after confirming that the first and second authentication tags match.

16. One or more non-transitory computer readable media containing instructions that when executed cause a device comprising at least a persistent storage device and cryptographic circuitry to:
generate a first encryption key based on a first cryptographic operation performed by the cryptographic circuitry and involving a cryptographic key securely stored in a memory of the cryptographic circuitry;
encrypt data to be protected using the first encryption key; and
store the encrypted data on the persistent storage device external to the cryptographic circuitry.

17. The one or more non-transitory computer readable media of claim 16, further containing instructions that when executed cause the device to:
retrieve the encrypted data from the persistent storage device;
generate a second encryption key based on a second cryptographic operation performed by the cryptographic circuitry and involving the cryptographic key, the second encryption key matching the first encryption key; and
decrypt the encrypted data using the second encryption key.

18. The one or more non-transitory computer readable media of claim 16, wherein:
the data to be protected comprises one or more private cryptographic keys associated with one or more profiles;
the instructions that when executed cause the device to decrypt the encrypted data comprise instructions that when executed cause the device to decrypt the one or more private cryptographic keys; and
further containing instructions that when executed cause the device to use the one or more decrypted private cryptographic keys to establish at least one mutually-authenticated connection with at least one remote service.

19. The one or more non-transitory computer readable media of claim 16, wherein:
the cryptographic key comprises an asymmetric private cryptographic key;
further containing instructions that when executed cause the device to generate a public-private key pair;
the first cryptographic operation is based on a public key of the public-private key pair and the private cryptographic key and generates a shared secret; and
the instructions that when executed cause the device to generate the first encryption key comprise instructions that when executed cause the device to generate the first encryption key using the shared secret; and
the instructions that when executed cause the device to encrypt the data to be protected comprise the instructions that when executed cause the device to encrypt the data to be protected using the first encryption key and an initialization vector.

20. The one or more non-transitory computer readable media of claim 16, wherein:
the cryptographic key comprises a symmetric secret cryptographic key;
further containing instructions that when executed cause the device to generate an unpredictable value;
the first cryptographic operation is based on the unpredictable value and the symmetric secret cryptographic key and generates a shared secret;
the instructions that when executed cause the device to generate the first encryption key comprise instructions that when executed cause the device to generate the first encryption key using the shared secret; and
the instructions that when executed cause the device to encrypt the data to be protected comprise the instructions that when executed cause the device to encrypt the data to be protected using the first encryption key and an initialization vector.
